(19) United States
(12) Patent Application Publication
(10) Pub. No.: US 2018/0370315 A1
(43) Pub. Date: Dec. 27, 2018

(54) TRANSVERSE LEAF SPRING ARRANGEMENT OF A CHASSIS AXLE OF A MOTOR VEHICLE

(71) Applicant: Dr. Ing. h.c. F. Porsche Aktiengesellschaft, Stuttgart (DE)

(72) Inventor: Andreas Higle, Stuttgart (DE)

(73) Assignee: Dr. Ing. h.c. F. Porsche Aktiengesellschaft, Stuttgart (DE)

(21) Appl. No.: 15/975,178

(22) Filed: May 9, 2018

(30) Foreign Application Priority Data
Jun. 23, 2017 (DE) 102017113961.3

(51) Int. Cl. B60G 11/113; B60G 11/44; B60G 11/08

(52) U.S. Cl. CPC B60G 11/113; B60G 11/44; B60G 2204/418; B60G 2204/424; B60G 11/08

(57) ABSTRACT

A transverse leaf spring arrangement of a chassis axle of a motor vehicle having a transverse leaf spring which is mounted via two outer bearing members on, in each case, one wheel support and via two central bearing members on a vehicle body. The central bearing members have, in each case, one torque generation apparatus, the torque directions of which run parallel to a longitudinal axis of the motor vehicle. The torque generation apparatus capable of generating a torque which is variable at least in a manner which is dependent on a deflection at the outer bearing members.

### CROSS-REFERENCE TO RELATED APPLICATION

This application claims priority to German Patent Application No. DE 10 2017 113 961.3, filed Jun. 23, 2017, which is incorporated by reference herein in its entirety.

### FIELD OF THE INVENTION

The present invention relates to a transverse leaf spring arrangement of a chassis axle of a motor vehicle having a transverse leaf spring which is mounted via two outer bearing members on in each case one wheel support and via two central members on a vehicle body, the central bearing members having in each case one torque generation apparatus, the torque directions of which run parallel to a longitudinal axis of the motor vehicle.

### BACKGROUND OF THE INVENTION

A transverse leaf spring arrangement is part of a chassis. The wheels, the wheel suspension, the spring system, the shock absorbers and the steering system belong to a chassis. The transverse leaf spring arrangement has substantially a transverse leaf spring which is mounted via two outer bearing members in each case to a wheel support and via two central bearing members on a vehicle body. It is possible via the embodiment of the transverse leaf spring and/or its influence to achieve a spring rate, stabilization properties and a ride level regulation of the vehicle. Here, the spring rate has a crucial influence on the deflection of the motor vehicle, the stabilization properties have a crucial influence on the body roll behavior of the vehicle, and the ride level regulation has a crucial influence on the ride height.

DE 10 2010 042 222 A1, which is incorporated by reference herein, has then disclosed assigning what are known as torque generation apparatuses to the central bearing members. Depending on the direction of the longitudinal axis in which a torque is generated, the spring rate, the stabilization properties and the ride level can be influenced as a result. It is thus possible, for example, by way of a generation of torques with identically directed torque directions in the central bearings, to produce a greater wheel contact force at one wheel than at the inner wheel, which counteracts body roll of the motor vehicle. By virtue of the fact that torques with opposed torque directions are generated, it is also possible, for example, to change the ride height in such a way that an additional weight in the case of pronounced loading of the motor vehicle can be compensated for.

An arrangement of this type has the disadvantage, however, that, for example, effects of the driving dynamics cannot be taken into consideration sufficiently by way of the application of a defined preset torque.

### SUMMARY OF THE INVENTION

Described herein is a transverse leaf spring arrangement of a chassis axle, which transverse leaf spring arrangement avoids the abovementioned disadvantage in a simple way.

The torque generation apparatus has means which generate a torque which is variable at least in a manner which is dependent on a deflection at the outer bearing member. It is possible as a result to bring about an adaptation of chassis characteristics in a particularly simple way.

In one advantageous embodiment, the means consist of a rubber bearing, in particular configured as a hydromount, with a variable torsional stiffness. A means of this type is suitable, in particular, for being installed with an identically oriented torque direction and thus for improving the body roll properties of the motor vehicle.

In one alternative embodiment, the means consist of a torsion spring with a variable torsional stiffness. A variable torque is produced in a simple way via a change of the windings which are in engagement. The torsion spring is also suitable, in particular, for installation with an identically directed torque direction.

A particularly advantageous embodiment of a transverse leaf spring arrangement according to aspects of the invention is produced by virtue of the fact that the means consist of an actuator for generating the variable torque, at least one control apparatus being provided which sets the torque in a manner which is dependent on at least one input variable. In this way, torques which are directed in the same direction or in opposite directions can be generated by way of the actuator, and can produce an optimum adaptation of the spring rate, the stabilization properties or the ride height in a manner which is dependent on an operating situation of the vehicle. Here, the actuator can be of electric, hydraulic or pneumatic configuration.

Moreover, means can be provided in an advantageous way which adjust the central bearing members in the direction of the vertical axis and/or transverse axis of the motor vehicle. Means can likewise be provided which adjust the outer bearing members in the direction of the vertical axis and/or transverse axis.

### BRIEF DESCRIPTION OF THE DRAWINGS

The invention will be described in greater detail using a drawing, in which:

FIG. 1 shows a front view of a motor vehicle having a diagrammatically illustrated transverse leaf spring arrangement,

FIG. 2 shows a diagrammatic illustration of the transverse leaf spring arrangement according to aspects of the invention, and

FIG. 3 shows a diagram which shows the overall torque profile of a transverse leaf spring in the case of different torques.

### DETAILED DESCRIPTION OF THE INVENTION

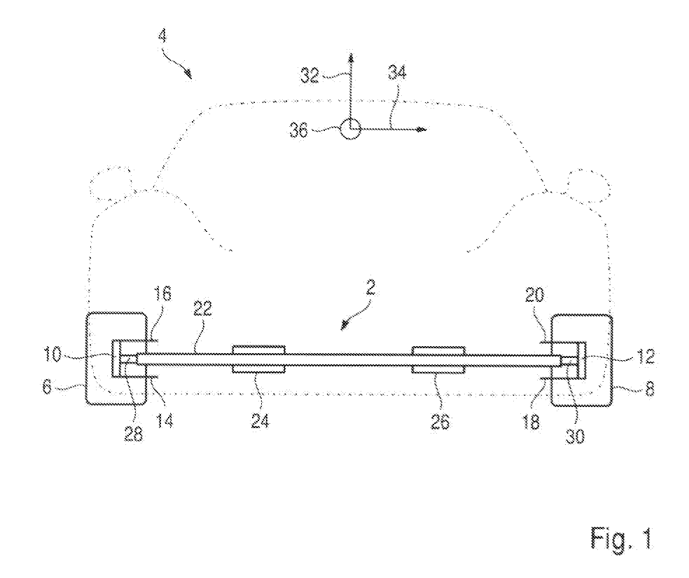

FIG. 1 shows a diagrammatic front view of a transverse leaf spring arrangement 2 according to aspects of the invention which is a constituent part of a front axle arrangement (not shown in further detail) of a motor vehicle 4. The designations 6, 8 denote two front wheels which are arranged in each case in a known way on wheel supports 10, 12. The wheel supports 10, 12 are connected, inter alia, via diagrammatically shown links 14, 16, 18, 20 to a vehicle body (not shown in detail) of the motor vehicle 4. A transverse leaf spring 22 of the transverse leaf spring arrangement 2 is mounted via central bearing members 24, 26 on the vehicle body of the motor vehicle 4 and via outer bearing members 28, 30 on the wheel supports 10, 12. In a known way, the motor vehicle 4 has a vertical axis 32, a transverse axis 34 and a longitudinal axis 36.

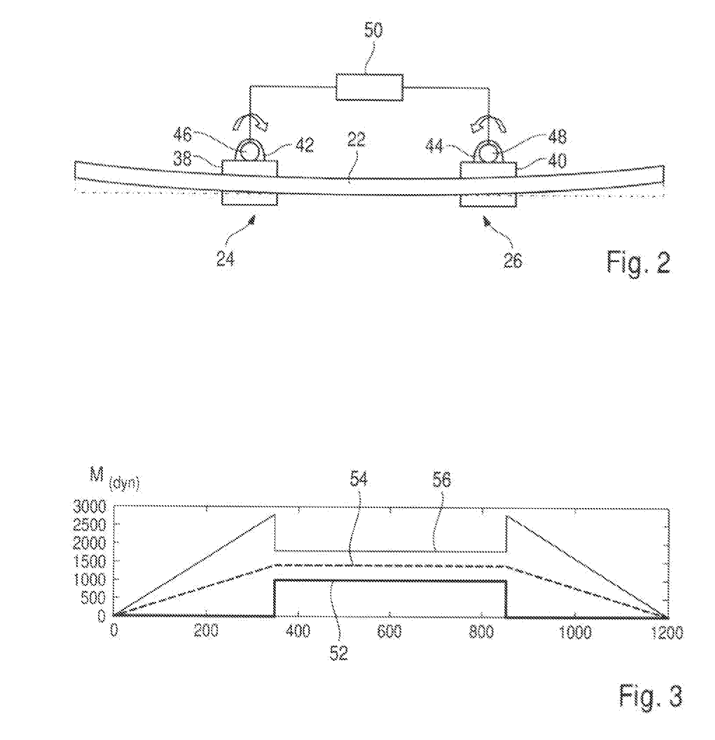

FIG. 2 shows a diagrammatic detailed view of the transverse leaf spring 22 with the central bearing members 24, 26. The outer bearing members 28, 30 are not shown here. The central bearing members 24, 26 in each case have a bearing shell 38, 40; furthermore, torque generation apparatuses 42, 44 are shown diagrammatically which can generate a variable torque. Here, the torque generation apparatuses 42, 44 can have means 46, 48 which generate a variable torque. Said means can be configured as passive means, such as a rubber bearing, in particular a hydromount, a torsion bar or else a torsion spring with variable torsional stiffnesses. In the present exemplary embodiment, however, actuators 46, 48 are provided which are connected to a control apparatus 50 which sets a torque in a manner which is dependent on at least one input variable.

In the present exemplary embodiment, torques which are directed toward one another are applied to the bearing shells 38, 40, the torques which are directed counter to one another running parallel to the longitudinal axis 36. As a result, the transverse leaf spring 22 is bent with respect to its starting state which is shown using dashed lines, in such a way that a ride level increase of the ends of the transverse leaf spring 22 takes place. The vehicle body of the motor vehicle 4 is therefore lowered, which has an advantageous effect in the case of relatively great loading. The control apparatus 50 provides the torque to be set by way of the actuators 42, 44, in a manner which is dependent on the deflection of the respective wheels 6, 8.

FIG. 3 shows a diagram with the overall torque profile of the overall torque which acts in the transverse leaf spring 22 over its length with the differently applied torques in a manner which is dependent on the deflection of the wheels 6, 8. The first line 52 shows the overall torque profile of a zero deflection. The second line 54 shows the overall torque profile in the case of an average deflection level, and the line 56 shows the overall torque profile in the case of a high deflection.

It should be clear that many input variables can be used, in order to set the torques of the actuators 42, 44 in the respective operating situations. Moreover, the central bearing members can also be adjusted in the direction of the vertical axis and/or transverse axis of the motor vehicle, and the outer bearing members can be adjusted in the direction of the vertical axis and/or transverse axis of the motor vehicle.

What is claimed is:

1. A transverse leaf spring arrangement of a chassis axle of a motor vehicle, said transverse leaf spring arrangement comprising:
a transverse leaf spring mounted via two outer bearing members on, in each case, one wheel support
the transverse leaf spring remounted via two central bearing members on a vehicle body,
the central bearing members having, in each case, one torque generation apparatus, torque directions of which run parallel to a longitudinal axis of the motor vehicle,
wherein each torque generation apparatus has means which generate a torque which is variable at least in a manner which is dependent on a deflection at the outer bearing members.

2. The transverse leaf spring arrangement as claimed in claim 1, wherein the means comprises a rubber bearing with a variable torsional stiffness.

3. The transverse leaf spring arrangement as claimed in claim 1, wherein the means comprises a torsion bar with a variable torsional stiffness.

4. The transverse leaf spring arrangement as claimed in claim 1, wherein the means comprises a torsion spring with a variable torsional stiffness.

5. The transverse leaf spring arrangement as claimed in claim 1, wherein the means comprises an actuator for generating the variable torque, and at least one control apparatus which sets the torque in a manner which is dependent on at least one input variable.

6. The transverse leaf spring arrangement as claimed in claim 1, wherein means are provided which adjust the central bearing members in a direction of a vertical axis or a transverse axis of the motor vehicle.

7. The transverse leaf spring arrangement as claimed in claim 1, wherein means are provided which adjust the outer bearing members in a direction of a vertical axis or a transverse axis of the motor vehicle.

8. The transverse leaf spring arrangement as claimed in claim 1, wherein the means comprises a hydromount with a variable torsional stiffness.
